(19) United States
(12) Patent Application Publication
(10) Pub. No.: US 2008/0026818 A1
(43) Pub. Date: Jan. 31, 2008

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/582,414

(22) Filed: Oct. 18, 2006

Related U.S. Application Data
(60) Provisional application No. 60/818,320, filed on Jul. 5, 2006.

(51) Int. Cl. A63F 13/00

(52) U.S. Cl. 463/20

(57) ABSTRACT

When a combination of symbols rearranged in a unit game during the execution of the base game is a specific combination, a transition is made to a stop control game for stopping the scrolled symbols by pressing a stop switch, as a second game. Then, a prize is awarded when the symbols are stopped as the player presses the stop switch and a winning combination is stopped on a payline.

### CROSS REFERENCE TO RELATED APPLICATIONS

This application claims priority to co-pending U.S. provisional patent application Ser. No. 60/818,320 filed on Jul. 5, 2006, and which is incorporated by reference herein for all purposes.

### BACKGROUND OF THE INVENTION

1. Field of the Invention

The present invention relates to a slot machine for playing games by using a game medium such as coin or bill, and a playing method of the slot machine.

2. Description of Related Art

In the related slot machine such as those disclosed in U.S. Pat. No. 6,960,133 and U.S. Pat. No. 6,012,983, when a player inserts the game medium such as medal, coin or bill into an insertion slot of the slot machine and presses a spin button, a plurality of symbols are scrolled at a display unit provided on a front side of a cabinet, and then each symbol is automatically stopped. At this point, a lottery of random numbers is carried out when the scrolling of the symbols is started at a timing of an input of the spin button. When a payout of a mystery bonus or a transition to a second game is won by this lottery of random numbers, a transition from the base game to the second game is made and the second game is executed.

Then, the slot machine is made to pay out a prize according to the winning combination that occurs in the course of the game.

In such a related slot machine, the game comprises only the automatic stopping of the scrolled symbols, so that there are demands for new slot machines that are much more entertaining.

### SUMMARY OF THE INVENTION

The first aspect of the present invention is a slot machine comprising a controller and a display, wherein in a case where a combination of rearranged symbols is a specific combination as a result of rearranging a plurality of symbols arranged on the display in a first game, the controller makes a transition to a second game in which the symbols can be rearranged arranged according to a control input signal from an external.

The second aspect of the present invention is a slot machine comprising a controller and a display, wherein the controller is configured to rearrange a plurality of symbols arranged on the display in a first game, and in a case where a combination of rearranged symbols is a specific combination as a result of rearrangement, the controller makes a transition from the first game in which the rearrangement of the symbols is completed automatically to a second game in which the symbols can be rearranged according to a control input signal from an external during a prescribed time limit period.

The third aspect of the present invention is a slot machine, comprising: a display on which a symbol matrix formed by a plurality of columns and a plurality of rows is to be arranged; a first controller for executing a first game in which a plurality of symbols arranged on the display are scrolled and then rearranged into a new symbol matrix, by selectively determining those symbols to be arranged into the symbol matrix from a plurality of types of symbols and automatically stopping scrolling at the determined symbols; a stop switch operable by a player; and a second controller for executing a second game in which the stop switch is set active and the scrolling is stopped in order to rearrange the symbol matrix on the display in relation to an input timing of the stop switch by the player, when a combination of the symbols arranged on a payline that is set with respect to the symbol matrix rearranged by the first controller in the first game is a specific combination.

The fourth aspect of the present invention is a playing method of a slot machine, comprising: repeating unit games in which a plurality of symbols are rearranged from a state of being arranged on a display into a combination of symbols determined by a controller; and enabling a transition to a second game in which the symbols are rearranged by the controller according to a control input signal due to an operation of a player, in a case where the combination of the symbols determined by the controller in the first game in which the symbols are automatically rearranged is a specific combination of the symbols.

The fifth aspect of the present invention is a playing method of a slot machine, comprising: arranging a plurality of symbols on a display, executing a first game in which the plurality of symbols arranged on the display are automatically rearranged, by a controller, and enabling rearrangement of the plurality of symbols independently from a control of the controller by a stop switch connected to the controller; and making a transition to a second game in which the stop switch is set active and a control of the rearrangement of the symbols is executed by an input of the stop switch, when a combination of the symbols rearranged in the first game is a specific combination. The above described stop switch may be a mechanical button switch, or a switch such as a touch panel, and it suffices to be a switch for triggering the generation of the input signal, which can be operated by the player from an external.

### BRIEF DESCRIPTION OF THE DRAWINGS

FIG. 1 is a flow chart showing a gaming method using a slot machine according to one embodiment of the present invention.

FIG. 2 is a diagram showing an outward appearance of a slot machine according to one embodiment of the present invention.

FIG. 3 is a diagram showing symbols displayed on a display window provided in the slot machine and code numbers of the symbols according to one embodiment of the present invention.

FIG. 4 is a block diagram showing a control circuit of the slot machine according to one embodiment of the present invention.

FIG. 5 is a flow chart showing a procedure of an authentication and reading processing of a game program and a game system program by a mother board and a gaming board of the slot machine according to one embodiment of the present invention.

FIG. 6 is a flow chart showing a processing procedure of a base game to be executed by the slot machine according to one embodiment of the present invention.

FIG. 7 is a flow chart showing a processing procedure of a second game to be executed by the slot machine according to one embodiment of the present invention.

FIGS. 8A to 8C are diagrams showing exemplary displays on a display window in the slot machine according to one embodiment of the present invention.

FIG. 9 is a diagram showing an exemplary display for notifying that a stop control game is being played, in the slot machine according to one embodiment of the present invention.

### DETAILED DESCRIPTION OF THE INVENTION

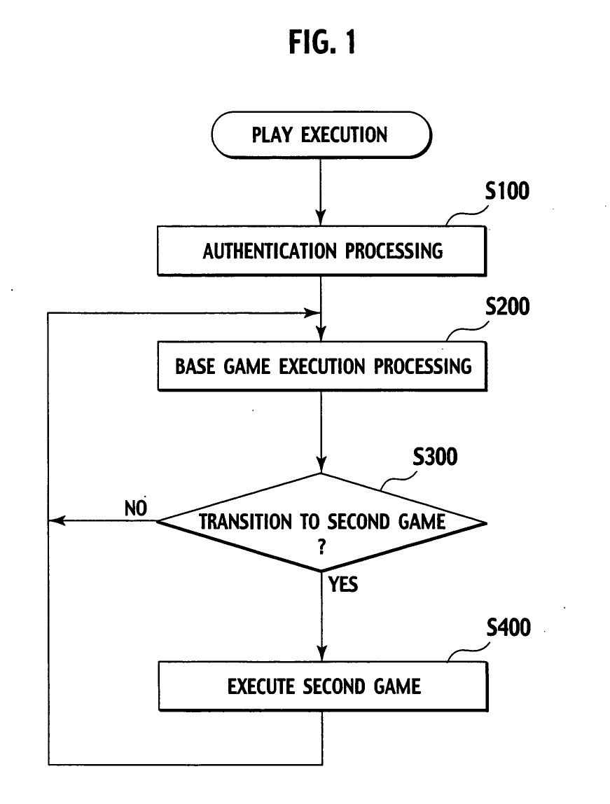

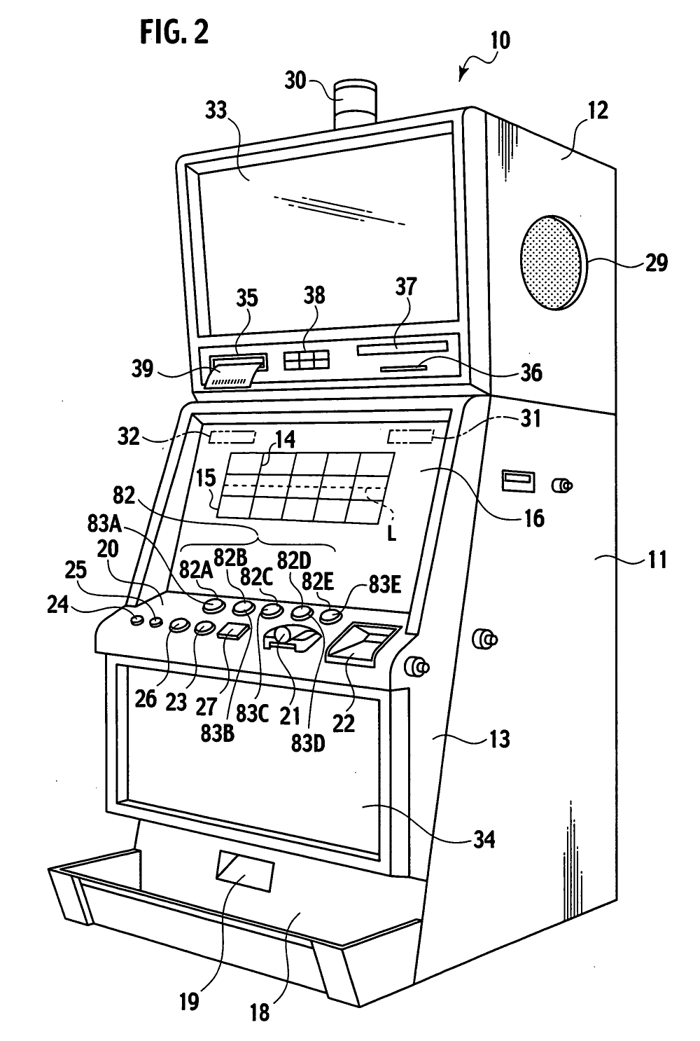

FIG. 1 is a flow chart schematically showing a playing method of a slot machine according to one embodiment of the present invention. In the following, the schematic operations in the slot machine and the playing method according to one embodiment of the present invention will be described with references to the flow chart shown in FIG. 1 and a diagram shown in FIG. 2.

In the slot machine according to one embodiment of the present invention, when the power is turned on and the slot machine is activated, an authentication processing is carried out first (step S100). In this authentication processing, the initial checking processing at a preliminary stage before starting a unit game, such as whether a program for operating the system is operating normally or not, whether there is any falsification of a program or not, etc., is carried out.

Next, a base game (first game) according to a base game program (first program) is executed (step S200). In the base game, when a spin button 23 is pressed in a state where a desired credit amount is bet by entering coins into a coin slot 21 or the like, a unit game in which the scrolling of symbols for which the video reels are adopted is started and then stopped is executed. In each unit game, a stopping symbol determination processing for determining a combination of the symbols to be automatically stopped, and a processing for determining those symbols that are to become the winning combination of symbols in the second game and the number of times for which these symbols can be stopped, are carried out.

Next, whether to make a transition to the second game or not is judged, by judging whether a combination of symbols to be automatically stopped by the stopping symbol determination processing is a stopping combination (a symbol combination to become a second game trigger: a specific combination) of symbols of the second game for making a transition to the second game according to the second game program (second program) or not (step S300). In the case of not making a transition to the second game (step S300 NO), a transition to a next unit game is made. In the case where the symbols to become the winning combination associated with a payout are stopped, a payout of a prescribed number of coins is made, and then a transition to a next unit game is made.

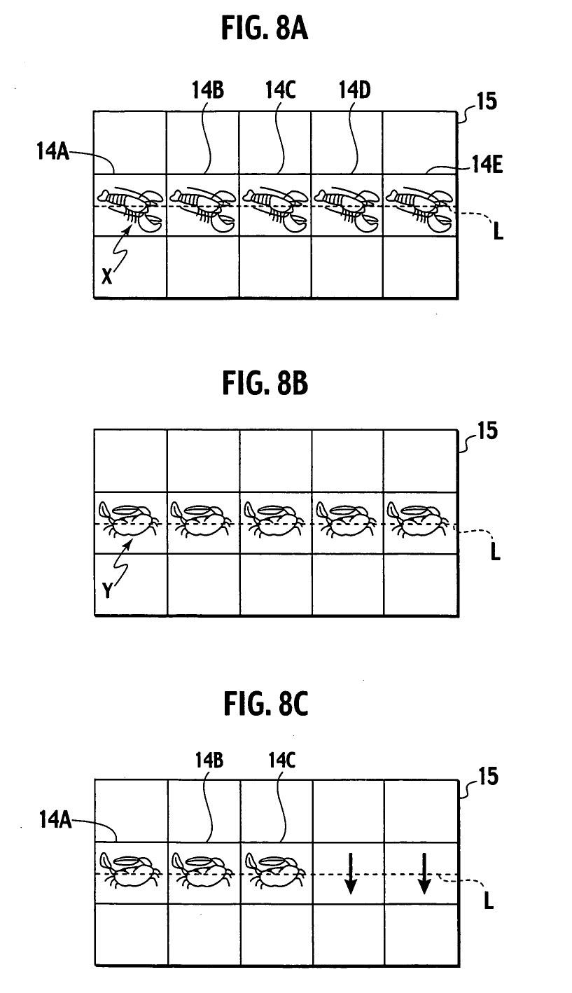

In the case of making a transition to the second game (step S300 YES), the symbols are automatically stopped at a stopping combination (a symbol combination to become a second game trigger) of symbols of the second game determined by the stopping symbol determination processing described above, and the second game according to the second program is executed (step S400). Here, the stopping combination (a symbol combination to become a second game trigger: a specific combination) of the symbols of the second game is assumed to be five lobster symbols X aligned as shown in FIG. 8A. Namely, a state in which the lobster symbol is stopped at each one of five variable display units 14 (14A. 14B, 14C. 14D, 14E) on the payline L of the variable display units 14 within the display window 15 of the video reels will be the stopping combination (a symbol combination to become a second game trigger) of the symbols of the second game.

For the second game, there is a stop control game, and in the present invention, the case of executing the stop control game will be described.

The stop control game is a game in which the scrolled symbols are stopped when a stop switch 82 (see FIG. 2) is pressed by the player.

In the stop control game, it is made possible to stop the scrolled symbols at the winning combination associated with a payout, at the display position of the display window 15 of the video reel scheme with becomes visible to the player, as the player presses the stop switch 82. This winning combination is determined by the execution of the base game (first game) at the step S200, and it is made possible to stop five crab symbols Y in alignment as the winning combination on the payline L as shown in FIG. 8B, for example.

Then, in this stop control game, at the display position of the display window 15, it is set in such a state that the crab symbols are stopped on the payline L of the left three variable display units 14A, 14B and 14C while only the symbols of the right two variable display units 14D and 14E are scrolled, as shown in FIG. 8C, and it is possible to become the winning combination in which five crab symbols are aligned by the operation for pressing the stop switch 82 by the player.

In other words, when the player presses the stop switch 82, if the scrolled crab symbols are located right at the position of the display window 15 (on the payline L), or the crab symbols are located in vicinity on the upper side of the display window 15, the crab symbols will be stopped on the payline L. In the case where the crab symbols do not exist at the above described positions, the crab symbols will not be stopped on the payline L.

As described above, in the case where the stop control game is executed, it is possible to stop (left two) scrolled symbols by the stopping operation of the stop switch 82 by the player in the second game. Then, by stopping the crab symbols, if five crab symbols are stopped to be aligned on the payline L, it becomes the winning combination, and a payout of a prescribed number of coins is made.

Then, it is made such that the stop control game can be executed consecutively for as many times as the stopping possible number of times determined according to the stopping possible number of times of the symbols to become the winning combination in the second game that is determined by the determination processing in the execution of the base game (first game) at the step S200. For example, in the case where the stopping possible number of times is 10, the payout of 10 coins will be made every time the winning combination in which five crab symbols are stopped to be aligned is realized, and the payout of 100 coins will be made in the case where the winning combination is realized ten times. The payout of 50 coins will be made in the case where the winning combination is realized only five times while the stopping possible number of times is 10, and 50 coins that were not possible to obtain in five failed attempts will be added as the jackpot value.

The above described example is directed to the case of aligning five symbols by the operation of five stop switches 82A, 82B, 82C, 82D and 82E (see FIG. 2), but it is also possible to align symbols of the other number, such as aligning three symbols by the operation of three stop switches, or aligning one symbol by the operation of one stop switch, for example. It is also possible to use a configuration for sequentially aligning five symbols by the operation of one stop switch.

The present invention is also applicable to the slot machine adopting the mechanical reels, without being limited to the case of using the video reels as in the present embodiment. Moreover, the above described example is directed to an exemplary case of displaying symbols by scrolling at the display window 15 adopting the video reel scheme and stopping them in the unit game, but it is also possible to display images of the symbols on the display window 15 and the images of the symbols arranged on the display window 15 are displayed (rearranged) by changing them to images of the other symbols in each unit game, for example.

Next, a configuration of the slot machine 10 according to one embodiment of the present invention will be described with reference to a diagram shown in FIG. 2. The slot machine 10 is provided within a gaming facility.

In the slot machine 10, the coins, bills or electronic value information corresponding to these will be used as the game medium for executing the unit game. However, the game medium that can be used in the present invention is not limited to these, and can be medals, tokens, electronic money, or tickets, for example. The tickets are not limited to any particular tickets and can be tickets with bar codes, for example, as will be described below. In the present embodiment, the game medium is a medal.

As shown in FIG. 2, the slot machine 10 has a cabinet 11, a top box 12 provided on an upper side of the cabinet 11, and a main door 13 provided on a front side of the cabinet 11. The slot machine 10 adopts the video reel scheme such that the stopping or scrolling of many types of symbols is visible through the display window 15 on the lower side image display panel 16 of the cabinet 11, as if five reels with many types of symbols are depicted thereon are rotating or stopping.

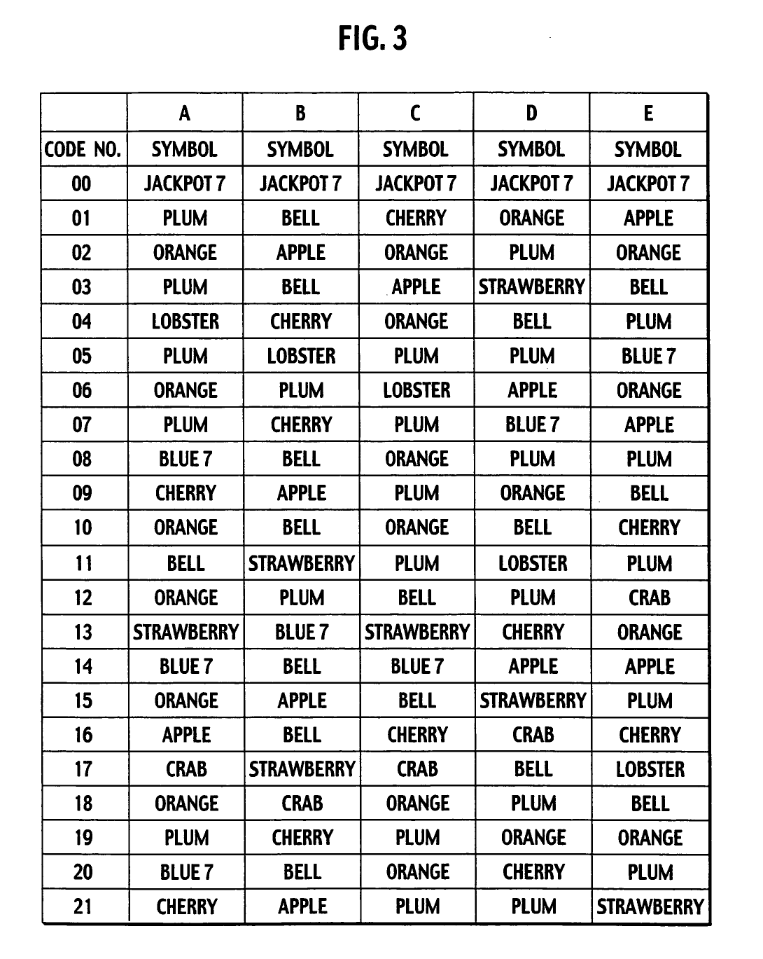

Each variable display unit 14 within the display window 15 is made to display one of 22 symbols, as shown in FIG. 3.

Namely, the fifteen variable display units 15 will display the symbol matrix formed by a plurality of columns and a plurality of rows. In the present embodiment, the exemplary case of using the video reel scheme as a display is described, but it is also possible to display symbols by scrolling using the mechanical reel scheme.

The lower side image display panel 16 has a transparent liquid crystal panel, on which various information regarding the game and the effect images will be displayed during the game.

On the lower side image display panel 16, the display window 15, a credit amount display unit 31 and a payout amount display unit 32 are provided. On the credit amount display unit 31, the number of coins credited is displayed by an image. On the payout amount display unit 32, the number of coins to be paid in the case where a combination of symbols that are stopped on the payline L is the winning combination as will be described below is displayed by an image.

On the lower side image display panel 16, the display window 15 is formed such that its back side is visible, and the symbols are displayed in the fifteen variable display units 14 through this display window 15. On-the lower side image display panel 16, one payline L that runs across the fifteen variable display units 14 horizontally is formed. The payline L specifies a combination of symbols. In the case where a combination of symbols that are stopped on the payline L is the winning combination, the number of coins according to the number of entered coins (BET number) and that combination of symbols will be paid.

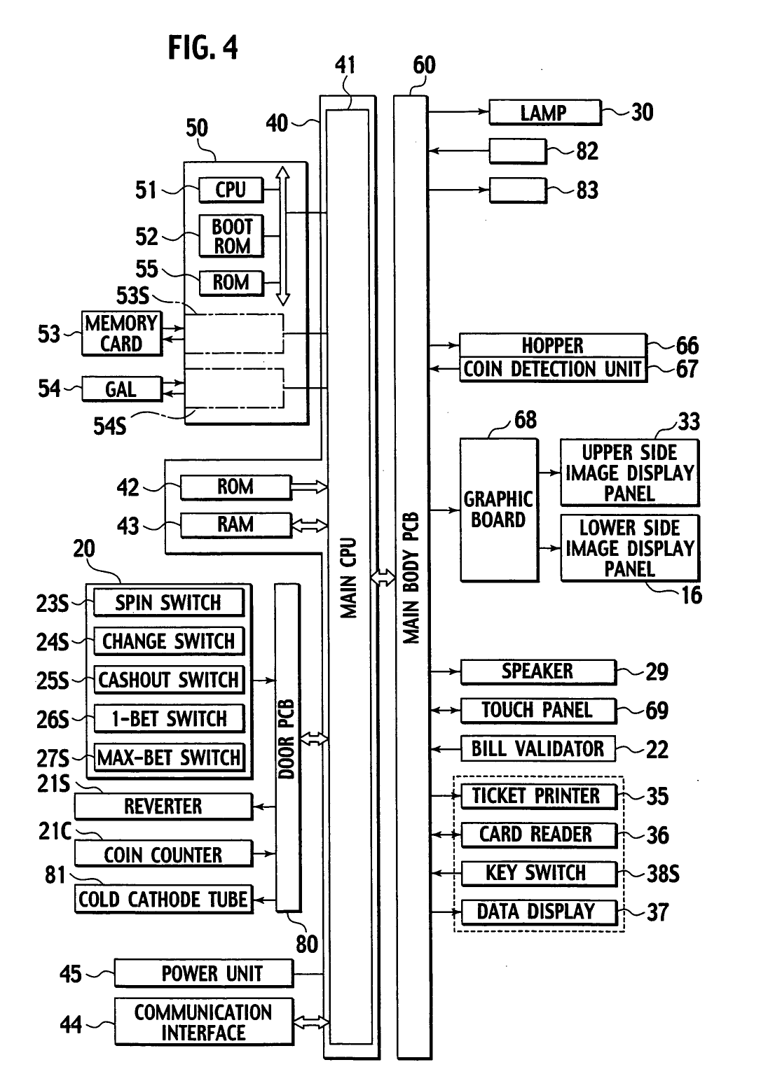

In the present embodiment, an exemplary case of setting one horizontally running payline L will be described, but it is also possible to set paylines L that run across the fifteen variable display units 14 obliquely such that as many paylines L as according to the number of coins entered are set active and the payout of as many coins as according to the winning combination will be made in the case where a combination of symbols which are stopped on the active paylines L is the winning combination. On a front face of the lower side image display panel 16, a touch panel 69 (see FIG. 4) is provided, such that the player can input various types of commands by operating the touch panel 69.

On a lower side of the lower side image display panel 16, a control panel 20 having a plurality of buttons 23-27 through which commands regarding the progress of the game will be inputted by the player, five stop switches 82 (82A, 82B, 82C, 82D, 82E), the coin slot 21 for receiving coins into the cabinet 11, and a bill validator 22 are provided. The present embodiment uses a configuration in which the mechanical stop switches 82 corresponding to five variable display units 14 on the payline L are provided, but without being limited to this configuration, it is also possible to arrange transparent touch panels on a front side of the display window 15 and use these touch panels as the stop switches 82. For such a touch panel, the touch panel used in the mobile terminal or the bank's ATM can be used. By arranging a touch panel on a front side of the display windows 15 as the stop switch 82 in this way, the player can enter a command for the rearrangement by watching the changing states of the scrolled symbols through the display windows while the reels 14 rotate and touching the symbols at which it is desired to be stopped (rearranged) through the display windows. Such a rearrangement operation has an advantage in that it can be done in a manner that simulates the direct touching of the symbols.

As described above, the number of the stop switches 82 is not limited to five, and can be three or one.

The present embodiment is directed to a configuration in which mechanical type stop switches 82 corresponding to the five variable display units 14 on the payline L are provided, but without being limited to this, it is also possible to use a configuration in which one stop switch 82 that contributes to the rearrangement of only one variable display unit 14 is provided. In this way, it becomes possible to switch the playing mode from a playing mode in which the player contributes to the rearrangement of all (five in the present embodiment) variable display units 14 by the input of the stop switches to a playing mode in which the player contributes to the rearrangement of one of them only.

On the control panel 20, a spin button 23, a change button 24, a cashout button 25, a 1-BET button 26, and a Max-BET button 27 are provided. The spin button 23 is a button for inputting a command for starting rotating the reels 14. The change button 24 is a button to be used at a time of requesting changes to an attendant of the gaming facility. The cashout button 25 is a button for inputting a command for paying the credited coins to a coin tray 18.

The 1-BET button 26 is a button for inputting a command for betting one coin among the credited coins to the game. The Max-BET button 27 is a button for inputting a command for betting maximum number (50, for example) of coins that can be bet per game among the credited coins to the game.

The stop switches 82 (82A, 82B, 82C, 82D, 82E) are switches for the player to carry out an operation to stop the scrolled symbols, which are set active when the stop control game is started. To the stop switches 82 (82A, 82B, 82C, 82D, 82E), display lamps 83 (83A, 83B, 83C, 83D, 83E) are provided, and each display lamp 83 (83A, 83B, 83C, 83D, 83E) is lit when the operation of each stop switch 82 (82A, 82B, 82C, 82D, 82E) is set active so as to notify that the operation of each stop switch 82 (82A, 82B, 82C, 82D, 82E) is set active to the player, as will be described below. It is also possible to use an operation lever, a track ball, a touch panel, etc., instead of the stop switch 82.

The bill validator 22 validates whether a bill is the legitimate one or not and accepts a legitimate bill into the cabinet 11. The bill validator 22 may have a configuration capable of reading a bar code attached ticket 39 to be described below. On the lower front surface of the main door 13, that is on the lower part of the control panel 20, there is provided a berry glass 34 on which characters of the slot machine 10 and the like are depicted.

On a front surface of the top box 12, an upper side image display panel 33 is provided. The upper side image display panel 33 has a liquid crystal panel for displaying the effect image or the image for introducing the game content or explaining game rules, for example.

On the top box 12, a speaker 29 for outputting sound is provided. On the lower side of the upper side image display panel 33, a ticket printer 35, a card reader 36, a data display 37, and a key pad 38 are provided. The ticket printer 35 prints a bar code which encodes data such as the credit amount, the date and time, the identification number of the slot machine 10, etc., on the ticket, and outputs it as the bar code attached ticket 39. The player can use the bar code attached ticket 39 to play the game on another slot machine or exchange the bar code attached ticket 39 with the bills or the like at the cashier or the like of the gaming facility.

The card reader 36 carries out reading of data from a smart card and writing of data into a smart card. The smart card is a card to be owned by the player, which stores data for identifying the player or data regarding log of games played by the player, for example.

The data display 37 comprises a fluorescent display or the like, and displays data read by the card reader 36, or data inputted by the player through the key pad 38, for example. The key pad 38 inputs data and commands regarding the ticket issuance or the like.

FIG. 3 is a diagram showing a series of symbols to be displayed on the display window 15. On each one of the variable display units 14A, 14B, 14C, 14D and 14E of the display window 15, 22 symbols will be displayed sequentially along their columns.

Here, the state in which the lobster symbols X are stopped at the five variable display units 14 (14A, 14B, 14C, 14D, 14E) on the payline L will be the symbol combination for realizing the second game trigger (a symbol combination for making a transition to the second game) (see FIG. 8A).

In the stop control game, the state in which the crab symbols Y are stopped at the five variable display units 14 (14A, 14B, 14C, 14D, 14E) on the payline L will be the winning combination (see FIG. 8B).

The scrolling of the symbols will start when the 1-BET button 26 or the Max-BET button 27 is pressed and then the spin button 23 is pressed. Namely, the symbols are scrolled from an upper direction to a lower direction at the display window 15, and then stopped after a prescribed time has elapsed. At this point, one of the symbols is stopped at the display window 15. A game from a start of the scrolling of the symbols until the subsequent stopping of the symbols will constitute the unit game. Namely, a game in which symbols arranged on the display are scrolled and rearranged will constitute the unit game.

Moreover, for each symbol, various types of winning combinations are predetermined, and when the symbols that constitute the winning combination are stopped on the payline L, the number of coins to be paid according to the winning combination is added to the credit owned by the player. When the second game trigger is realized, that is, when the lobster symbols are stopped on the payline L in the present embodiment, a transition of the game mode from the base game mode to the second game mode is made.

FIG. 4 is a block diagram showing a control circuit of the slot machine 10 shown in FIG. 2. As shown in FIG. 4, the control circuit comprises a mother board 40, a main body PCB (Printed Circuit Board) 60, a gaming board 50, a door PCB 80, and various types of switches and sensors.

The gaming board 50 has a CPU (Central Processing Unit) 51, a ROM 55 and a boot ROM 52, a card slot 53S corresponding to a memory card 53, and an IC socket 54S corresponding to a GAL (Generic Array Logic) 54, which are mutually connected through an internal bus.

The memory card 53 stores a game program and a game system program. The game program includes a stopping symbol determination processing program. The stopping symbol determination processing program is a program for determining the symbols (code numbers corresponding to the symbols) to be stopped on the payline L. This stopping symbol determination processing program contains symbol weighing data respectively corresponding to plural types of payout rates (80%, 84%, 88%, for example). The symbol weighing data are data indicating the correspondence relationship between the code number of each symbol and one or a plurality of random number values belonging to a prescribed numerical value range (0 to 256), for each of the five columns.

The payout rate is determined according to the payout rate setting data outputted from the GAL 54. The stopping symbol determination processing is carried out according to the symbol weighing data corresponding to the payout rate.

The card slot 53S is formed such that the memory card 53 can be inserted or extracted, and connected to the mother board 40 through the IDE bus. Consequently, by extracting the memory card 53 from the card slot 53S, writing the other game program and game system program into the memory card 53, and inserting that memory card 53 into the card slot 53S, it is possible to change a type and a content of the game to be played on the slot machine 10.

The game program includes a first program for executing the base game and a second program for executing the second game as programs related to the game progress, and a program for making a transition to the second game. The game program also contains the image data and sound data to be outputted during the game. The game program also contains the image data and the sound data as notification data for notifying that the stopping operation of the symbols by the stop switches 82 is possible to the player, when the second game is won and the second game trigger is not realized.

The GAL 54 has a plurality of input ports and output ports, and when data are inputted into the input ports, data corresponding to these data are outputted from the output ports. The data outputted from the output ports are the payout rate setting data mentioned above.

The IC socket 54S is formed such that the GAL 54 can be attached or detached, and connected to the mother board 40 through the PCI bus. Consequently, by detaching the GAL 54 from the IC socket 54S, rewriting the program stored in the GAL 54, and attaching that GAL 54 to the IC socket 54S, it is possible to change the payout rate setting data to be outputted from the GAL 54.

The CPU 51, the ROM 55 and the boot ROM 52 that are mutually connected through the internal bus are connected to the mother board 40 through the PCI bus. The PCI bus carries out the signal transmission between the mother board 40 and the gaming board 50, as well as the power supply from the mother board 40 to the gaming board 50. The ROM 55 stores a country identification information and an authentication program. The boot ROM 52 stores a spare authentication program and a program (boot codes) for the CPU 51 to activate the spare authentication program.

The authentication program is a program (falsification checking program) for authenticating the game program and the game system program. Namely, the authentication program is a program for carrying out the checking and the verification of the fact that the game program and the game system program are not falsified. The authentication program is described along a procedure for carrying the authentication of the game program and the game system program. The spare authentication program is a program for authenticating the above described authentication program. The spare authentication program is described along a procedure for carrying out the verification that the authentication program that is a target of the authentication processing is not falsified, that is, the authentication of the authentication program.

The mother board 40 has a main CPU (controller) 41, a ROM (Read Only Memory) 42, a RAM (Random Access Memory) 43, and a communication interface 44.

The main CPU 41 has a function of a controller for controlling the entire slot machine 10. In particular, the main CPU 41 carries out a control for outputting a command signal for rotating each stepping motor 70 to a motor driving circuit 62 when the credit is bet and the spin button 23 is pressed, a control for determining symbols to be stopped at a position of the display window 15 (on the payline L) after the symbols are set in the scrolling state, and a control for stopping the symbols such that the determined symbols will be stopped at the position of the display window 15. Namely, the main CPU 41 has a function of an arrangement controller which, after a plurality of symbols displayed at the display are scrolled, selects and determines symbols to be arranged into a symbol matrix from plural types of symbols, and executes an arrangement control for stopping the scrolling state at the determined symbols, in order to rearrange them into a new symbol matrix.

The Main CPU 41 has a function of a stop switch controller which sets the stop switches 82 active and stops the scrolling state for executing the rearrangement of the symbol matrix on the display according to the control input signal related to the input timing of the stop switches 82 by the player, only when it is determined that the combination of symbols arranged on the payline L that is set with respect to the symbol matrix is the specific combination.

The ROM 42 stores programs such as BIOS (Basic Input/Output System) to be executed by the main CPU 41, as well as data to be used permanently. When the BIOS is executed by the main CPU 41, the processing for initializing each peripheral device is carried out and the processing for reading the game program and the game system program stored in the memory card 53 through the gaming board 50 is started, and they are stored into the RAM 43.

The RAM 43 stores data and programs to be used when the main CPU 41 carries out the processing. The RAM 43 has a region for storing a variable “n” for indicating the number of times for which the stop control game has been executed, which will be described below.

The communication interface 44 carries out communications with the host computer or the like that is provided inside the gaming facility through a communication channel.

To the Mother board 40, a main body PCB (Printed Circuit Board) 60 and a door PCB 80 to be described below are connected through the respective USB (Universal Serial Bus). Also, a power source unit 45 is connected to the mother board 40. When the power is supplied from the power source unit 45 to the mother board 40, the main CPU 41 of the mother board 40 is activated, and the power is supplied to the gaming board 50 through the PCI bus and the CPU 51 is activated.

To the main body PCB 60 and the door PCB 80, devices for generating input signals to be inputted into the main CPU 41 and devices whose operations are to be controlled by control signals outputted from the main CPU 41 are connected. The main CPU carries out the calculation processing and stores its result into the RAM 43 by executing the game program and the game system program stored in the RAM 43 according to the input signals inputted into the main CPU 41, and carries out the processing for transmitting control signals to each device as the control processing with respect to each device.

To the main body PCB 60, a lamp 30, a hopper 66, a coin detection unit 67, a graphic board 68, a speaker 29, a touch panel 69, a bill validator 22, a ticket printer 35, a card reader 36, a key switch 38S, and a data display 37 are connected. To the main body PCB 60, five stop switches 82, and five display lamps 83 provided in correspondence to the stop switches 82 are also connected.

The lamp 30 is controlled to be turned on or off according to the control signal outputted from the main CPU 41.

The hopper 66 is provided inside the cabinet 11, and pays the prescribed number of coins according to the control signal outputted from the main CPU 41, from a coin payout opening 19 to a coin tray 18. The coin detection unit 67 is provided inside the coin payout opening 19, and outputs an input signal with respect to the main CPU 41 when it is detected that the prescribed number of coins are paid from the coin payout opening 19.

The graphic board 68 controls the image display on the upper side image display panel 33 and the lower side image display panel 16 according to the control signal outputted from the main CPU 41. On the credit amount display unit 31 of the lower side image display panel 16, the credit amount stored in the RAM 43 is displayed. On the payout amount display unit 32 on the lower side image display panel 16, the number of coins to be paid is displayed. The graphic board 68 has a VDP (Video Display Processor) for generating image data according to the control signal outputted from the main CPU 41 and a video RAM for temporarily storing the image data generated by the VDP.

The bill validator 22 reads an image of the bill and accepts the legitimate bill into the cabinet 11. The bill validator 22 outputs an input signal with respect to the main CPU 41 according to the amount of that bull when the legitimate bill is accepted. The main CPU 41 stores the credit amount according to the amount of the bill notified by that input signal into the RAM 43.

The ticket printer 35 prints the bar code which encodes data such as the credit amount stored in the RAM 43, the date and time, and the identification number of the slot machine 10, etc., on the ticket, according to the control signal outputted from the main CPU 41, and outputs it as the bar code attached ticket 39.

The card reader 36 reads data from the smart card and transmit it to the main CPU 41, or writes data into the smart card according to the control signal outputted from the main CPU 41. The key switch 38S is provided on the key pad 38, and outputs an input signal to the main CPU 41 when the key pad 38 is operated by the player.

The data display 37 displays the data read by the card reader 36 or the data inputted by the player through the key pad 38, according to the control signal outputted from the main CPU 41.

The stop switches 82 are buttons for stopping the scrolled symbols when the stop control game to be described below is executed. As will be described below, when a transition to the second game is made, the stop switches 82 are set active, and the display lamps 83 are lit. Then, the main CPU 41 carries out a control to stop the symbols at a timing of the pressing of the stop switches 82 by the player.

To the door PCB 80, a control panel 20, a reverter 21S, a coin counter 21C and a cold cathode tube 81 are connected. On the control panel 20, a spin switch 23S corresponding to a spin button 23, a change switch 24S corresponding to a change button 24, a cashout switch 25S corresponding to a cashout button 25, a 1-BET switch 26S corresponding to a 1-BET button 26, and a max BET switch 27S corresponding to a max BET button 27 are provided. Each one of the switches 23S to 27S outputs an input signal with respect to the main CPU 41 when the corresponding one of the buttons 23-27 is operated by the player.

The coin counter 21C is provided inside the coin slot 21, and validates whether coins entered at the coin slot 21 are legitimate ones or not. Those coins that are not the legitimate ones will be ejected from the coin payout opening 19. The coin counter 21C outputs an input signal with respect to the main CPU 41 when the legitimate coins are detected.

The reverter 21S is operated according to a control signal outputted from the main CPU 41, to distribute the coins recognized as the legitimate coins by the coin counter 21C to the cash box (not shown) provided inside the slot machine 10 or the hopper 66. Namely, when the hopper 66 is filled with coins, the legitimate coins are distributed to the cash box by the reverter 21S. On the other hand, when the hopper 66 is not filled with coins, the legitimate coins are distributed to the hopper 66.

The cold cathode tube 81 functions as the background light provided on the back side of the lower side image display panel 16 and the upper side image display panel 33, and it is turned on according to a control signal outputted from the main CPU 41.

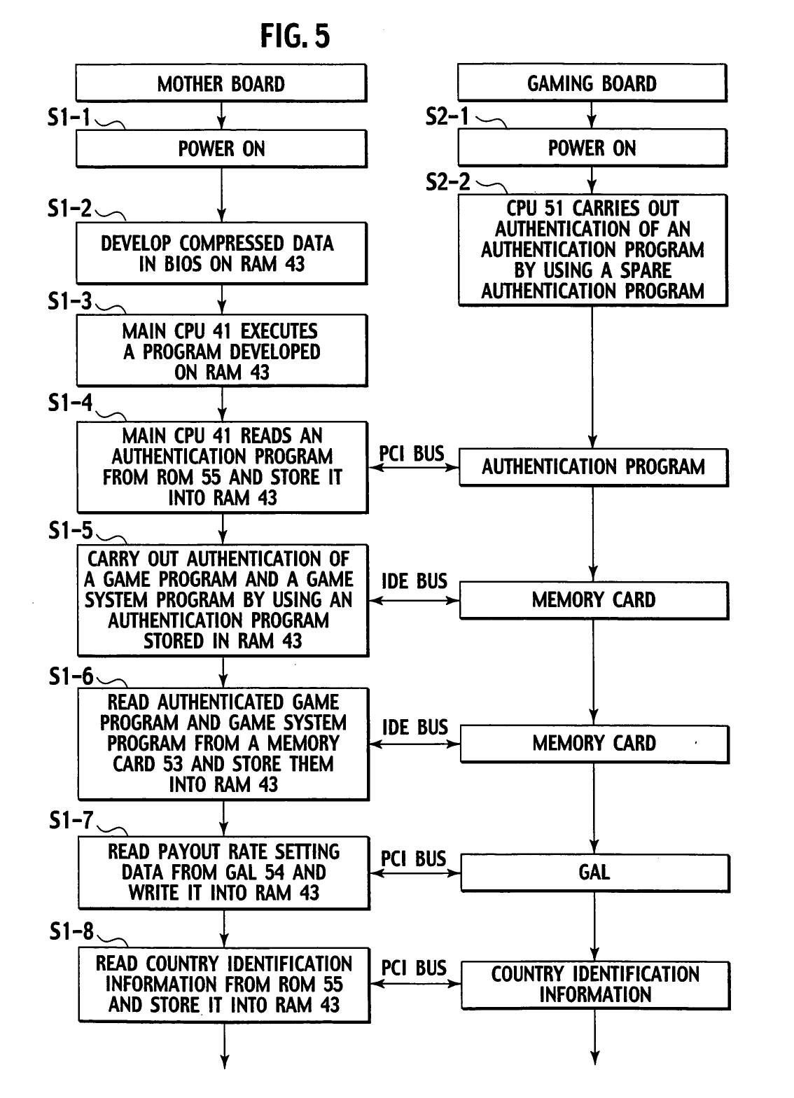

Next, the concrete processing to be carried out at the slot machine 10 will be described. FIG. 5 is a flow chart showing a procedure of the authentication and reading processing for the game program and the game system program (processing at the step S100 shown in FIG. 1), by the mother board 40 and the gaming board 50 shown in FIG. 4. Here it is assumed that the memory card 53 is attached to the card slot 53S and the GAL 54 is attached to the IC socket 54S on the gaming board 50.

First, when the power switch is turned on at the power source unit 45, the mother board 40 and the gaming board 50 are activated (steps S1-1, S2-1). When the mother board 40 and the gaming board 50 are activated, the respective independent processings will be carried out in parallel. Namely, at the gaming board 50, the CPU 51 carries out the reading of the spare authentication program stored in the boot ROM 52, and the spare authentication for checking and verifying that the authentication program is not falsified in advance, according to the read out spare authentication program, before it is taken into the mother board 40 (step S2-2).

On the other hand, at the mother board 40, the main CPU 41 executes the BIOS stored in the ROM 42 and expands the compressed data incorporated in the BIOS over the RAM 43 (step S1-2). Then, the main CPU 41 executes the BIOS expanded on the RAM 43 to carry out the diagnosis and initialization of various types of peripheral devices (step S1-3).

Then, as the ROM 55 of the gaming board 50 is connected to the main CPU 41 through the PCI bus, the main CPU 41 carries out the reading of the authentication program stored in the ROM 55. The main CPU 41 carries out the processing for storing the read out authentication program into the RAM 43 (step S1-4).

Next, the main CPU 41 makes an access to the memory card 53 that is attached to the card slot 53S through the IDE bus. Then, the main CPU 41 carries out the reading of the game program and the game system program stored in the memory card 53.

Next, the main CPU 41 carries out the authentication for checking and verifying that the read out game program and game system program are not falsified, according to the authentication program stored in the RAM 43 (step S1-5).

When this authentication processing is finished normally, the main CPU 41 stores the authenticated game program including the first game program and game system program into the RAM 43 (step S1-6). Next, the main CPU 41 makes an access to the GAL 54 that is attached to the IC socket 54S through the PCI bus, reads out the payout rate setting data from the GAL 54, and stores it into the RAM 43 (step S1-7). Next, the main CPU 41 carries out the reading of the country identification information stored in the ROM 55 of the gaming board 50, and stores the read out country identification information into the RAM 43 (step S1-8).

After carrying out the above described processing, the main CPU 41 activates, sequentially reads out and executes the base game program (first program) stored in the RAM 43, to proceed with the base game as described below.

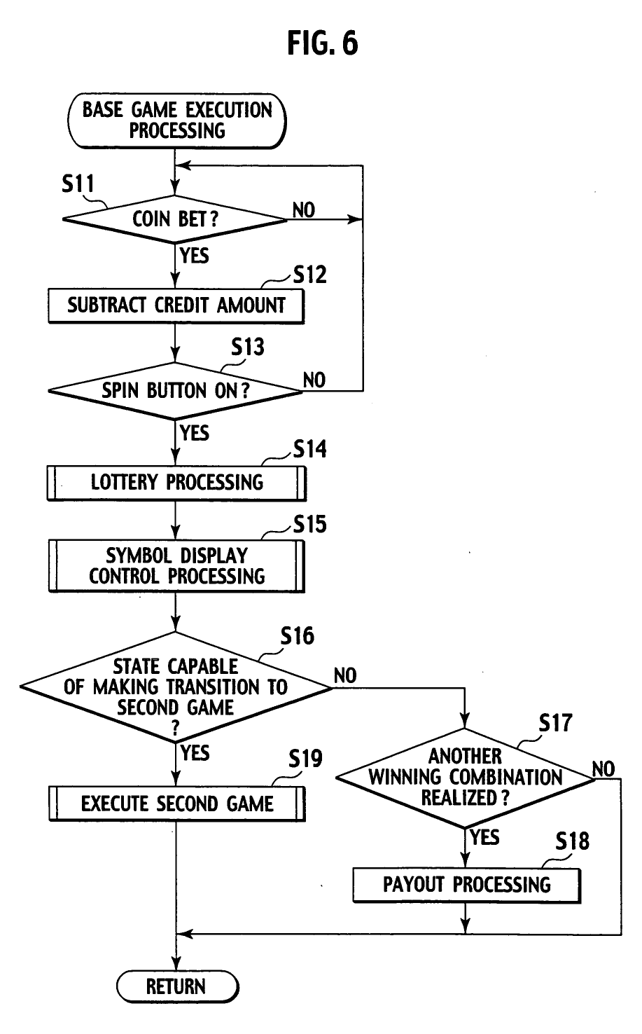

After the authentication and reading processing shown in FIG. 5 is carried out, the main CPU 41 carries out the base game execution processing according to the base game program (first program). FIG. 6 is a flow chart showing the concrete processing procedure of the base game execution processing shown at the step S200 of FIG. 1.

In the base game execution processing, first, the main CPU 41 judges whether the coin BET has been made or not (step S11). In this processing, the main CPU 41 judges whether the input signal outputted from the 1-BET switch 26S when the 1-BET button 26 is pressed or the input signal outputted from the max BET switch 27S when the max BET button 27 is pressed has been received or not. When it is judged that the coin BET has not been made, the processing returns to the step S11.

On the other hand, at the step S11, when it is judged that the coin BET has been made, the main CPU 41 carries out the processing for subtracting the credit amount stored in the RAM 43 according to the number of coins to be bet (step S12). When the number of coins to be bet is greater than the credit amount stored in the RAM 43, the processing is returned to the step S11, without carrying out the processing for subtracting the credit amount stored in the RAM 43. When the number of coins to be bet exceeds the upper limit value (50 in the present embodiment) that can be bet per one game, the processing proceeds to the step S13, without carrying out the processing for subtracting the credit amount stored in the RAM 43. In this state, the symbols in the display windows 15 are set in a state where it is possible to start scrolling.

Next, the main CPU 41 judges whether the spin button 23 is turned ON or not (step S13). In this processing, the main CPU 41 judges whether the input signal outputted from the spin switch 23S when the spin button 23 is turned ON is received or not.

When it is judged that the spin button 23 is not turned ON, the processing is returned to the step S11. In the case where the spin button 23 is not turned ON (the case where a command indicating the finishing of the game is inputted without turning the spin button 23 ON, for example), the main CPU 41 cancels the subtraction result at the step S12.

In the present embodiment, the exemplary case of carrying out the processing for subtracting the credit amount (step S12) after the coin BET is made (step S11), before making the judgement as to whether the spin button 23 is turned ON or not (step S13) will be described. However, the present invention is not limited to this exemplary case. For example, it is also possible to make the judgement as to whether the spin button 23 is turned ON or not (step S13) after the coin BET is made (step S11), and carry out the processing for subtracting the credit amount (step S12) when it is judged that the spin button 23 is turned ON (step S13 YES).

Then, at the step S13 of FIG. 6, when it is judged that the spin button 23 is turned ON, the main CPU 41 carries out the stopping symbol determination processing (step S14).

In the stopping symbol determination processing, the main CPU 41 determines a combination of the symbols to be stopped on the payline L by executing the stopping symbol determination processing program stored in the RAM 43.

In the present embodiment, the exemplary case of determining one winning combination for making a transition to the second game (see FIG. 8A) from a plurality of winning combinations by determining the combination of symbols to be displayed at a time of stopping will be described, but in the present invention, it is also possible to determine one winning combination selected from a plurality of winning combinations by the stopping symbol determination processing first, and then determine the combination of symbols to be stopped according to the above described winning combination, for example.

Next, the main CPU 41 carries out the symbol display control processing for the lower side image display panel 16 (step S15). This processing is a processing for starting scrolling of the symbols of all columns and then stopping scrolling of the symbols such that the arrangement of symbols corresponding to the winning combination determined at the step S14 will be stopped on the payline L.

Next, the main CPU 41 judges whether the symbols stopped on the payline L are the winning combination for making a transition to the second game (see FIG. 8A) or not, by referring to a table or the like that defines the winning combinations, and judges whether it becomes a state capable of making a transition to the second game or not (step S16).

When it is not in the state capable of making a transition to the second game (step S16 NO), the main CPU 41 judges whether symbols that constitute the other winning combination are stopped on the payline L or not by referring to a table or the like that defines the winning combinations (step S17). When it is judged that the symbols that constitute the other winning combination are stopped, the main CPU makes a payout of coins according to the number of coins entered and the winning combination (step S18). In the case of depositing the paid coins, the main CPU 41 adds the prescribed amount of credit to the credit amount stored in the RAM 43. In the case of paying the coins, the main CPU 41 makes the payout of a prescribed number of coins by transmitting the control signal to the hopper 66. At this point, the coin detection unit 67 counts the number of coins paid from the hopper 66, and transmits a payout completion signal to the main CPU 41 when the count value reached the specified number. As a result, the main CPU 41 stops the driving of the hopper 66 and finishes the coin payout processing.

At the step S17, when it is judged that none of the winning combinations is realized (when it is judged as a lost game), or when the processing of the step S18 is executed, the processing is finished.

On the other hand, in the processing of the step S16, when it is judged that it is the state capable of making a transition to the second game, the main CPU 41 activates the second game program (second program) stored in the RAM 43 and executes the second game (step S19: corresponding to the step S400 of FIG. 1).

Here, in the case of activating the second game program (second program) stored in the RAM 43 and executing the second game, the main CPU 41 functions as the second controller.

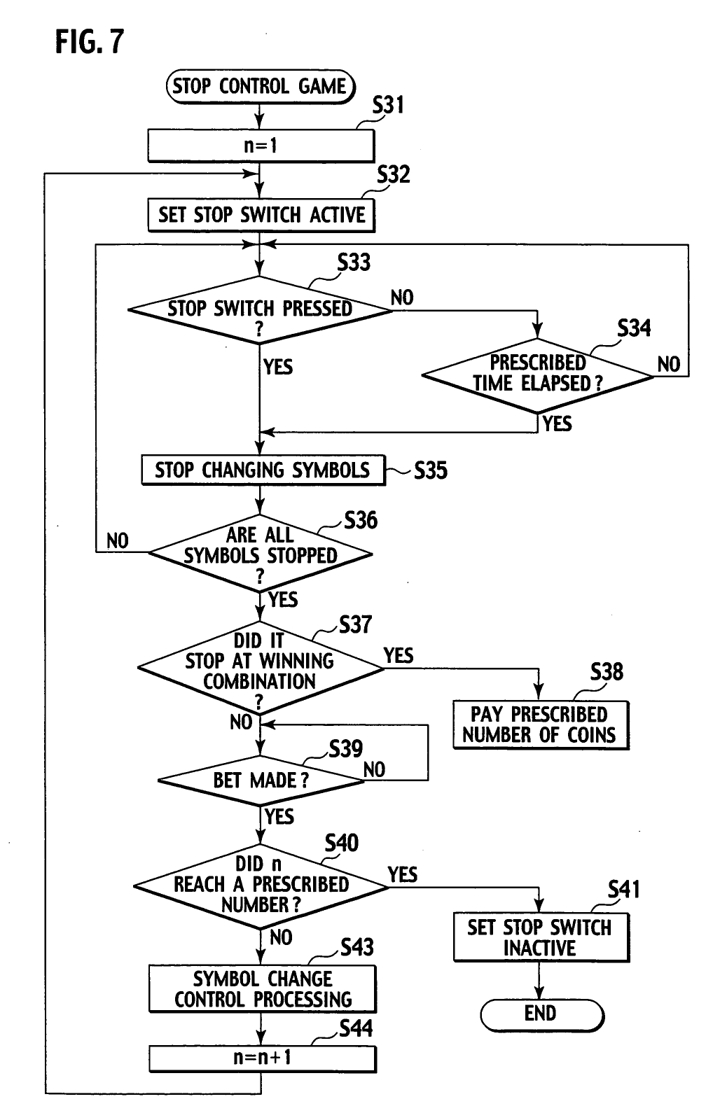

FIG. 7 is a flow chart showing the processing procedure of the stop control game which is the second game.

In the stop control game, first, a value of the variable “n” for indicating the number of times for which the stop control game has been executed is set to “1” (step S31). The value of this variable “n” is stored into the RAM 43. Next, the symbols are scrolled at the display window 15, and the five stop switches 82 shown in FIG. 2 are set active (step S32). Namely, it is set in a state where five scrolled symbols can be stopped by pressing the five stop switches 82.

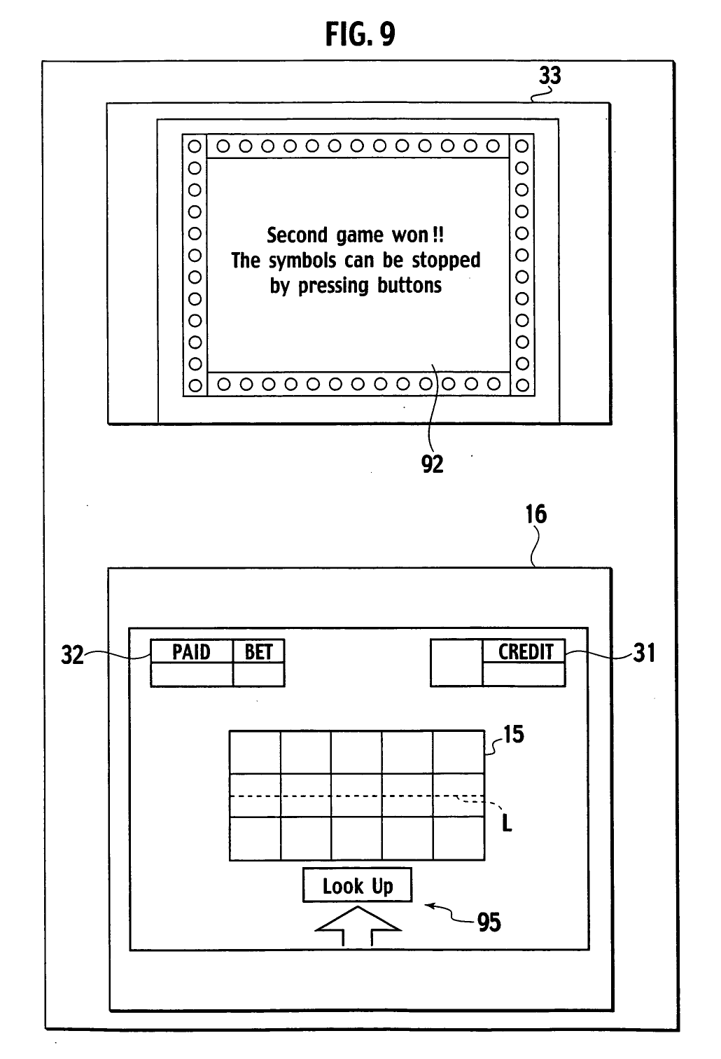

At this point, in order to notify that the operation of the stop switches 82 is possible to the player, as shown in FIG. 9, the letters of “Second Game Won!! The symbols can be stopped by pressing buttons” will be displayed on the upper side image display panel 33 of the slot machine 10. Moreover, the main CPU 41 carries out a control to turn the display lamps 83 of the stop switches 82 on.

Next, the main CPU 41 judges whether the stop switch 82 is pressed or not (step S33). When the stop switch 82 is pressed, the main CPU 41 stops scrolling of the symbols of the column corresponding to the pressed stop switch 82 (step S35).

In this case, the main CPU 41 stops the symbols corresponding to the pressed stop switch 82 when it is detected that the stop switch 82 is pressed by receiving the control input signal which is the detection signal of the detection sensor (not shown) provided at each stop switch 82.

Also, as shown in FIG. 8B, the main CPU 41 controls the stopping position of the symbols of each column such that he five crab symbols can be stopped in alignment as the winning combination, on the payline L provided at the display position of the display window 15. Namely, it is set in a state where it is possible to rearrange the scrolled symbols into the specific combination.

Namely, in the present embodiment, it is set in a state where the crab symbols are stopped on the payline L of the three left variable display units 14A, 14B and 14C while displaying the symbols of the right two variable display units 14D and 14E by scrolling, at the display position of the display window 15 as shown in FIG. 8C, such that it is possible to realize the winning combination in which the five crab symbols are aligned by the operation of pressing the stop switches 82 by the player.

Then, in the case where the five crab symbols are stopped in alignment on the payline L as a result of stopping the crab symbols, the winning combination is realized so that a payout of a prescribed number (10) of coins will be made.

In the case where the stop switches 82 are not pressed even after a prescribed time (time limit period) has elapsed (step S34 YES), the stop switches 82 are set inactive to put them in a state in which the control input signal cannot be transmitted to the main CPU 41 even when they are pressed, and the symbols are stopped automatically (step S35).

Then, the main CPU 41 judges whether the symbols of all columns are stopped or not (step S36). Then, when the symbols of all columns are not stopped, the processing is returned to the step S33. When the symbols of all columns are stopped, the main CPU 41 judges whether the stopped symbols are the winning combination in which five crab symbols are aligned or not (step S37).

Then, when the symbols are stopped at the winning combination in which five crab symbols are aligned, a payout of a prescribed number (10) of coins will be made.

On the other hand, when the symbols are not stopped at the winning combination, the main CPU 41 judges whether the 1-BET button 26 or the max-BET button 27 is pressed or not (step S39). When the 1-BET button 26 or the max-BET button is pressed, the main CPU 41 judges whether the number of times for which the stop control game has been executed at the current moment (which is stored in the RAM 43 as the variable “n”) has reached a prescribed number of times (10 times, for example) or not (step S40). The prescribed number of times (10 times, for example) of the stop control game is made such that it is determined by the execution of the base game (first game).

When it is judged that the number of times for which the stop control game has been executed has not reached the prescribed number of times, the main CPU 41 executes the symbol change control processing for each column (step S43), without carrying out the subtraction of the credit amount due to the pressing of the 1-BET button 26 or the max-BET button 27. Namely, when the 1-BET button 26 or the max-BET button 27 is pressed by the player after the symbols are stopped, the credit will not be consumed and the symbols are scrolled again without requiring the operation input at the spin button 23.

Next, the value of the variable “n” stored in the RAM 43 is incremented by one (step S44). At this point, the number of times for which the stop control game has been repeated is notified to the player by displaying an image of the value of the variable “n” on the upper side image display panel 33, or by outputting the sound corresponding to the value of the variable “n” from the speaker 29. After that, the processing is returned to the step S32.

By carrying out such a processing, it becomes possible to execute the stop control games consecutively for as many times as the stopping possible number of times determined according to the stopping possible number of times of the symbols to become the winning combination in the second game that is determined by the determination processing in the execution of the base game (first game). For example, in the case where the stopping possible number of times is 10, the payout of 10 coins will be made every time the winning combination in which five crab symbols are stopped to be aligned is realized, and the payout of 100 coins will be made in the case where the winning combination is realized ten times. The payout of 50 coins will be made in the case where the winning combination is realized only five times while the stopping possible number of times is 10, and 50 coins that were not possible to obtain in five failed attempts will be added as the jackpot value.

In the present embodiment, the 10 times of the stop control games are set as the time limit period, for example, but it is also possible to set the time limit period in terms of time such as “five minutes”, for example.

At the processing of the step S40, in the case where it is judged that the value of the variable “n” has reached the prescribed number of times (10 times, for example), namely, in the case where the stop control game has been executed for the prescribed number of times, the main CPU 41 sets the operation of the stop switches inactive and finishes the processing of the second game (step S41).

The processing of the step S39 described above is directed to an exemplary case in which the main CPU 41 displays the symbols by scrolling and executes the next stop control game without consuming the credit amount, when the 1-BET button 26 or the max-BET button 27 is pressed. However, similarly as in the base game, it is also possible to make a payout of the consumed credit amount whenever the credit is consumed and the symbols are stopped such that the unit game is finished, when the 1-BET button 26 or the max-BET button 27 is pressed. In this case, by pressing the 1-BET button 26 or the max-BET button 27, it will appear that the credit amount is decreased, but after the unit game is finished, it is returned to the credit amount before pressing the 1-BET button 26 or the max-BET button 27.

In the present embodiment, the winning combination of the symbols in the second game is determined by the base game (first game), but the present invention is not limited to this case. For example, it is also possible to judge the combination of the symbols stopped by the operation of the stop switches 82 by the user in the second game, and make the payout of the credit when that combination of the symbols is the prescribed winning combination, without determining the winning combination of the symbols in the second game by the base game (first game).

FIG. 9 shows exemplary images to be displayed on the upper side image display panel 33 and the lower side image display panel 16 when the stop control game is executed. On the lower part of the lower side image display panel 16, the display window 15 and the image 95 showing an arrow pointing upwards and “Look Up” are displayed. On the upper side image display panel 33, the image 92 indicating that the second game has won is displayed. The image 95 is an image for urging the player to look at the upper side image display panel 33.

On the upper side image display panel 33, letters “Second Game Won!! The symbols can be stopped by pressing buttons” are displayed. By looking at this display, the player can recognize that the scrolled symbols can be stopped by pressing the stop switches 82.

As described, in the slot machine and the playing method of the slot machine according to the present embodiment, when the combination of the symbols stopped in the base game is the specific combination, the transition to the second game is made, and the stop control game in which the player can stop the scrolled symbols by pressing the stop switches 82 will be started. Then, when the player presses the stop switches 82 to stop the symbols, and as a result, the winning combination is stopped on the payline L, the prize can be obtained.

In other words, in the slot machine and the playing method of the slot machine according to the present embodiment, when the combination of the symbols stopped in the base game is the specific combination, that is, when the combination of the symbols rearranged on the payline L is the specific combination, the stop control game in which the rearrangement of the symbols is possible by accepting the control input signal from the external that is generated as the stop switches 82 are pressed will be executed.

Consequently, when the combination of the symbols stopped in the base game is the specific combination, it is possible to provide the player with a new gaming aspect in which the winning combination can be realized by stopping the scrolled symbols by the pressing of the stop switches 82 by the player himself, so that it is possible to prevent the player from losing interests or attentions to the games.

In the case where the winning combination of the symbols is not stopped on the payline L even after executing the stop control game for the prescribed number of times (10 times, for example) that is set as the time limit period, the operation of the stop switches 82 will be set inactive.

In the above, the embodiment of the slot machine according to the present invention has been described, but it is only showing a concrete example which should not limit the present invention in any particular way, and the concrete configuration of each means or the like can be appropriately changed by design. Also, the effects described in the embodiment of the present invention are only listing the most preferable effects arising from the present invention, and the effects of the present invention are not limited to those described in the embodiment of the present invention.

What is claimed is:

1. A slot machine comprising a controller operable to, in a case where a combination of rearranged symbols is a specific combination as a result of rearranging a plurality of symbols arranged on the display in a first game, make a transition to a second game in which the symbols can be rearranged according to a control input signal from an external.

2. The slot machine of claim 1, wherein the controller determines a winning combination of the symbols for the second game, in the first game.

3. The slot machine of claim 1, wherein the controller finishes the second game after a prescribed time limit period has elapsed.

4. A slot machine comprising a controller operable to rearrange a plurality of symbols arranged on the display in a first game, and in a case where a combination of rearranged symbols is a specific combination as a result of rearrangement, make a transition from the first game in which the rearrangement of the symbols is completed automatically to a second game in which the symbols can be rearranged according to a control input signal from an external during a prescribed time limit period.

5. The slot machine of claim 4, wherein the controller determines a winning combination of the symbols for the second game, in the first game.

6. A slot machine comprising:
a display on which a symbol matrix formed by a plurality of columns and a plurality of rows is to be arranged;
a first controller operable to execute a first game in which a plurality of symbols arranged on the display are scrolled and then rearranged into a new symbol matrix, by selectively determining those symbols to be arranged into the symbol matrix from a plurality of types of symbols and automatically stopping scrolling at the determined symbols;
a stop switch operable by a player; and
a second controller operable to execute a second game in which the stop switch is set active and scrolling is stopped in order to rearrange the symbol matrix on the display in relation to an input timing of the stop switch by the player, when a combination of the symbols arranged on a payline that is set with respect to the symbol matrix rearranged by the first controller in the first game is a specific combination.

7. The slot machine of claim 6, wherein the second controller sets the stop switch inactive when the symbols are rearranged on the payline for a prescribed number of times, after the stop switch is set active.

8. The slot machine of claim 6, wherein the first controller determines a winning combination of the symbols for the second game, in the first game.

9. The slot machine of claim 6, wherein the second controller sets the stop switch inactive when a prescribed time limit period has elapsed after the stop switch is set active.

10. A playing method of a slot machine, comprising:
repeating unit games in which a plurality of symbols are rearranged from a state of being arranged on a display into a combination of symbols determined by a controller; and
enabling a transition to a second game in which the symbols are rearranged by the controller according to a control input signal due to an operation of a player, in a case where the combination of the symbols determined by the controller in the first game in which the symbols are automatically rearranged is a specific combination of the symbols.

11. The playing method of claim 10, wherein a processing of accepting the control input signal due to the operation of the player by the controller is finished after a prescribed time limit period has elapsed.

12. A playing method of a slot machine, comprising:
arranging a plurality of symbols on a display, executing a first game in which the plurality of symbols arranged on the display are automatically rearranged, by a controller, and enabling rearrangement of the plurality of symbols independently from a control of the controller by a stop switch connected to the controller; and
making a transition to a second game in which the stop switch is set active and a control of the rearrangement of the symbols is executed by an input of the stop switch, when a combination of the symbols rearranged in the first game is a specific combination.

13. The playing method of claim 12, further comprising: setting the stop switch inactive when a prescribed time limit period has elapsed after the stop switch is set active, and rearranging the symbols into the specific combination determined by the controller.
